(19) United States
(12) Patent Application Publication
(10) Pub. No.: US 2024/0076497 A1
(43) Pub. Date: Mar. 7, 2024

(54) PHASE CHANGE COMPOSITE AND PREPARATION METHOD AND USE THEREOF

(71) Applicant: Guangdong University of Technology, Guangzhou (CN)

(72) Inventors: Xinxi Li, Guangzhou (CN); Yuming Li, Guangzhou (CN); Guoqing Zhang, Guangzhou (CN); Xiaoqing Yang, Guangzhou (CN); Ziqian Wu, Guangzhou (CN)

(73) Assignee: Guangdong University of Technology, Guangzhou (CN)

(21) Appl. No.: 18/329,139

(22) Filed: Jun. 5, 2023

(30) Foreign Application Priority Data
Aug. 30, 2022 (CN) 202211057723.6

(51) Int. Cl. C08L 91/06

(52) U.S. Cl. CPC C08L 91/06

(57) ABSTRACT

The present disclosure belongs to the technical field of power batteries, and in particular relates to a phase change composite and a preparation method and use thereof. The phase change composite includes the following components in parts by weight: 50 parts to 70 parts of a phase change material (PCM), 10 parts to 20 parts of a maleic anhydride graft, 1 part to 5 parts of a thermal conductivity enhancer, and 15 parts to 30 parts of a flame retardant; where the flame retardant includes melamine and triphenyl phosphate. The phase change composite has flame retardancy, high latent heat, and great thermal conductivity.

### CROSS REFERENCE TO RELATED APPLICATION

This patent application claims the benefit and priority of Chinese Patent Application No. 202211057723.6, filed with the China National Intellectual Property Administration on Aug. 30, 2022, the disclosure of which is incorporated by reference herein in its entirety as part of the present application.

### TECHNICAL FIELD

The present disclosure belongs to the technical field of power batteries, and in particular relates to a phase change composite and a preparation method and use thereof.

### BACKGROUND

The rapid development of electric vehicles has led to the large-scale application of power batteries, as well as a large-scale decommission of the power batteries. If not being disposed of properly, these decommissioned batteries can cause enormous damage to the environment. The decommissioned power battery can continue to be used in occasions with low battery performance requirements, realizing the cascade utilization of decommissioned power batteries, which can effectively prolong a service life of the power battery and reduce a use cost of the power battery.

However, during the cascade utilization of decommissioned power batteries, inconsistencies and safety risks may continue to iteratively magnify. For example, decommissioned lithium-iron phosphate batteries during the cascade utilization may be in an accelerated aging period, with uneven battery temperature field and current density distribution. As a result, the inconsistency during cascade utilization of the battery may be exacerbated, and the risk of thermal runaway can even be caused by the local accumulation of heat, bringing safety hazards to the cascade utilization. Therefore, it is crucial for the application and development of decommissioned power batteries by exploring a battery thermal management system with higher heat dissipation and flame retardancy.

Phase change material (PCM)-based cooling technology is a new type of battery thermal management technology. Since the PCM can absorb/release a large amount of latent heat during the physical process of melting/solidification, this technology controls the temperature of batteries within a reasonable range, thereby ensuring the safety of batteries during use. However, most PCMs are flammable. In order to improve a flame retardant performance, it is generally necessary to add a large amount of flame retardants to the phase change substrate. Although flame retardants can improve the flame retardancy of PCMs, they also reduce the latent heat value and thermal conductivity of the PCMs, which greatly limits use of the PCMs in battery thermal management.

### SUMMARY

An objective of the present disclosure is to provide a phase change composite and a preparation method and use thereof. In the present disclosure, the phase change composite has excellent flame retardancy, high latent heat, and great thermal conductivity.

To achieve the above objective, the present disclosure provides the following technical solutions:

The present disclosure provides a phase change composite, including the following components in parts by weight:

50 parts to 70 parts of a phase change material (PCM), 10 parts to 20 parts of a maleic anhydride graft, 1 part to 5 parts of a thermal conductivity enhancer, and 15 parts to 30 parts of a flame retardant; where
the flame retardant includes melamine and triphenyl phosphate.

Preferably, the phase change composite includes the following components in parts by weight:
50 parts to 60 parts of the PCM, 11.5 parts to 20 parts of the maleic anhydride graft, 1 part to 3.5 parts of the thermal conductivity enhancer, and 15 parts to 25 parts of the flame retardant.

Preferably, the maleic anhydride graft is one or more selected from the group consisting of a maleic anhydride-grafted ethylene-vinyl acetate copolymer, a maleic anhydride-grafted ethylene-butene copolymer, and a maleic anhydride-grafted ethylene-1-octene copolymer.

Preferably, the thermal conductivity enhancer is one or more selected from the group consisting of boron nitride, expanded graphite, and aluminum nitride.

Preferably, the PCM is one or more selected from the group consisting of paraffin wax, stearic acid, lauric acid, and polyvinyl alcohol.

Preferably, the melamine and the triphenyl phosphate are at a mass ratio of 1:10 to 10:1.

The present disclosure further provides a preparation method of the phase change composite, including the following steps:
mixing the PCM, the maleic anhydride graft, the thermal conductivity enhancer, and the flame retardant to obtain the phase change composite.

Preferably, the mixing is conducted at 120° C. to 180° C.

Preferably, a process of the mixing includes the following steps:
conducting primary mixing on the PCM and the maleic anhydride graft to obtain a primary mixture;
conducting secondary mixing on the primary mixture and the flame retardant to obtain a secondary mixture; and
conducting tertiary mixing on the secondary mixture and the thermal conductivity enhancer.

The present disclosure further provides use of the phase change composite or a phase change composite prepared by the preparation method in a power battery.

The phase change composite includes the following components in parts by weight: 50 parts to 70 parts of a PCM, 10 parts to 20 parts of a maleic anhydride graft, 1 part to 5 parts of a thermal conductivity enhancer, and 15 parts to 30 parts of a flame retardant; where the flame retardant includes melamine and triphenyl phosphate. In the present disclosure, the melamine is used as a gas-phase flame retardant, while the triphenyl phosphate is used as a solid-phase flame retardant. The combined use of the above two has a synergistic effect to achieve an excellent flame-retardant effect. Meanwhile, both the triphenyl phosphate and the maleic anhydride graft can promote the uniform dispersion of each component in the system, and the composite formed has a more complete microstructure (less defects), providing more thermal conduction channels (phonon and photon channels), thereby improving the thermal conductivity of the composite. The triphenyl phosphate has a melting point close to that of the PCM, and can also exert a phase change function when being as a flame retardant in the phase change composite, thus further increasing an overall latent heat value of the composite. Accordingly, the phase change composite has flame retardancy, high latent heat, and great thermal conductivity.

### BRIEF DESCRIPTION OF THE DRAWINGS

FIG. 1 shows a result of an anti-leakage test of the phase change composites obtained in Examples 1 to 4 and Comparative Examples 1 to 4;

FIG. 2 shows a vertical combustion test of the phase change composites obtained in Example 3 and Comparative Examples 1 to 4;

FIG. 3 shows a heat release rate (HRR) test curve of the phase change composites obtained in Example 3 and Comparative Examples 1 to 4;

FIG. 4 shows a total heat release (THR) rate test curve of the phase change composites obtained in Example 3 and Comparative Examples 1 to 4;

FIG. 5 shows a smoke production rate (SPR) test curve of the phase change composites obtained in Example 3 and Comparative Examples 1 to 4;

FIG. 6 shows a total smoke production (TSP) rate test curve of the phase change composites obtained in Example 3 and Comparative Examples 1 to 4;

FIGS. 7A-J show a real picture and a scanning electron microscopy (SEM) image of a material obtained after combustion of the phase change composites obtained in Example 3 and Comparative Examples 1 to 4;

FIG. 8 shows a structural schematic diagram of a power battery module prepared from the phase change composite obtained in Example 3; and

FIGS. 9A-B show a temperature change curve of a battery module with MTPCM3 and FAC prepared from different phase change composites in the Test Example 5 during a charge-discharge process.

### DETAILED DESCRIPTION OF THE EMBODIMENTS

The present disclosure provides a phase change composite, including the following components in parts by weight:
50 parts to 70 parts of a PCM, 10 parts to 20 parts of a maleic anhydride graft, 1 part to 5 parts of a thermal conductivity enhancer, and 15 parts to 30 parts of a flame retardant; where
the flame retardant includes melamine and triphenyl phosphate.

In the present disclosure, all components are commercially available products well known to those skilled in the art unless otherwise specified.

In the present disclosure, in parts by weight, the phase change composite includes 50 parts to 70 parts, more preferably 50 parts to 60 parts, and even more preferably 55 parts to 58 parts of the PCM. In the present disclosure, the PCM is preferably one or more selected from the group consisting of paraffin wax, stearic acid, lauric acid, and polyvinyl alcohol; when the PCM is two or more of the above options, there is no special limitation on a specific ratio of the components, and the components can be mixed in any ratio. In a specific example, the paraffin wax is Joule paraffin wax produced by Shanghai Joule Wax Co., Ltd. In a specific example, the Joule paraffin wax has a melting point of 48.8° C. and a latent heat value of 225.7 J/g.

In the present disclosure, based on the parts by weight of the PCM, the phase change composite includes 10 parts to 20 parts, more preferably 11.5 parts to 20 parts, and even more preferably 13 parts to 15 parts of the maleic anhydride graft. The maleic anhydride graft is preferably one or more selected from the group consisting of a maleic anhydride-grafted ethylene-vinyl acetate copolymer, a maleic anhydride-grafted ethylene-butene copolymer, and a maleic anhydride-grafted ethylene-1-octene copolymer; when the maleic anhydride graft is two or more of the above options, there is no special limitation on a specific ratio of the components, and the components can be mixed in any ratio. In a specific example, the maleic anhydride graft is the maleic anhydride-grafted ethylene-vinyl acetate copolymer; in the maleic anhydride-grafted ethylene-vinyl acetate copolymer, maleic anhydride has a grafting ratio of 1.2%.

In the present disclosure, the maleic anhydride graft, as a flexible support skeleton and compatibilizer, can improve interfacial adhesion of the PCM and the additives, thereby improving compatibility and bonding properties of the PCM and the flame retardant, to promote the dispersion of flame retardant. In addition, the maleic anhydride graft can also undergo amidation with the melamine in the flame retardant to improve a thermal stability of the phase change composite.

In the present disclosure, based on the parts by weight of the PCM, the phase change composite includes 1 part to 5 parts, more preferably 1 part to 3.5 parts, and even more preferably 2 parts to 3 parts of the thermal conductivity enhancer. The thermal conductivity enhancer is preferably one or more selected from the group consisting of boron nitride, expanded graphite, and aluminum nitride; when the thermal conductivity enhancer is more than two of the above options, there is no special limitation on a specific ratio of the components, and the components can be mixed in any ratio.

In the present disclosure, based on the parts by weight of the PCM, the phase change composite includes 15 parts to 30 parts, more preferably 15 parts to 25 parts, and even more preferably 18 parts to 20 parts of the flame retardant. The flame retardant includes melamine and triphenyl phosphate. The melamine and the triphenyl phosphate are at a mass ratio of preferably 1:10 to 10:1, more preferably 2:10 to 9:1, more preferably 5:10 to 8:1. The triphenyl phosphate has a melting point of 50.7° C. and a latent heat value of 82.4 J/g; the triphenyl phosphate is used as a flame retardant in the phase change composite, and can also exert a phase change function, thereby improving the latent heat value and compatibility of the phase change composite. In an early stage of combustion of the phase change composite, nitrogen and nitrogen dioxide produced by decomposition of the melamine can effectively block the entry of oxygen, thereby inhibiting or slowing down the combustion reaction. The triphenyl phosphate can be decomposed into meta-polyphosphoric acid and other substances with strong dehydration properties at a high temperature. These substances cover a surface of the phase change composite to form flame-retardant substances, and can promote dehydration of the phase change composite into charcoal. Thus, a more effective expansion protection char layer is formed to further inhibit the progress of combustion.

In the present disclosure, the phase change composite has a melting point (phase change temperature) of preferably 46.9° C. to 47.8° C. The phase change composite has a thermal conductivity of preferably greater than 1.25 W/m·K, more preferably 1.39 W/m·K. The phase change composite has a phase-change latent heat value of preferably greater than 115 J/g, more preferably 130.0 J/g.

The present disclosure further provides a preparation method of the phase change composite, including the following steps:
mixing the PCM, the maleic anhydride graft, the thermal conductivity enhancer, and the flame retardant to obtain the phase change composite.

In the present disclosure, the mixing is conducted at preferably 120° C. to 180° C., more preferably 130° C. to 170° C., and even more preferably 150° C. to 160° C. The mixing is conducted preferably with stirring. There is no special limitation on conditions and parameters of the stirring, and the stirring can be conducted by a process well known to those skilled in the art.

In the present disclosure, the mixing preferably includes the following steps:
conducting primary mixing on the PCM and the maleic anhydride graft to obtain a primary mixture;
conducting secondary mixing on the primary mixture and the flame retardant to obtain a secondary mixture; and
conducting tertiary mixing on the secondary mixture and the thermal conductivity enhancer.

In the present disclosure, the primary mixing is conducted at preferably a temperature the same as that of the mixing described in the above-mentioned technical solution, which is not repeated here. The primary mixing is conducted preferably under stirring at preferably 300 r/min for preferably 60 min. The primary mixing is conducted preferably in a constant-temperature oil bath with an electric stirrer.

In the present disclosure, the secondary mixing is conducted at preferably a temperature the same as that of the mixing described in the above-mentioned technical solution, which is not repeated here. The secondary mixing is conducted preferably under stirring at preferably 500 r/min for preferably 120 min.

In the present disclosure, the tertiary mixing is conducted at preferably a temperature the same as that of the mixing described in the above-mentioned technical solution, which is not repeated here. The tertiary mixing is conducted preferably under stirring at preferably 500 r/min for preferably 120 min.

The present disclosure further provides use of the phase change composite or a phase change composite prepared by the preparation method in a power battery.

In the present disclosure, the use in the power battery is preferably use in a thermal management system of the power battery. The power battery includes preferably a newly-prepared power battery or a decommissioned power battery.

In the present disclosure, the phase change composite is preferably used as a raw material for preparation of a battery holder of the power battery.

In the present disclosure, a preparation method of the battery holder includes the following steps:
mixing the PCM, the maleic anhydride graft, the thermal conductivity enhancer, and the flame retardant, pouring an obtained mixture into a mold, and conducting demolding after cooling to a room temperature to obtain the battery holder.

In the present disclosure, a process of mixing is the same as the mixing of the PCM, the maleic anhydride graft, the thermal conductivity enhancer, and the flame retardant defined in the above technical solution, and is not repeated here.

In the present disclosure, there is no special limitation on a process of the cooling and demolding, which can be conducted by a process well known to those skilled in the art.

In the present disclosure, the phase change composite is applied to the thermal management system of the decommissioned power battery, and has excellent heat dissipation and temperature uniformity, thus improving the temperature consistency of the decommissioned power battery; meanwhile, when thermal runaway occurs, the phase change composite can also play a role of heat insulation, effectively inhibiting the expansion of battery thermal runaway.

In order to further illustrate the present disclosure, the phase change composite and the preparation method and the use thereof provided by the present disclosure are described in detail below with reference to the accompanying drawings and examples, but the accompanying drawings and the examples should not be construed as limiting the protection scope of the present disclosure.

### Example 1

60 parts of Joule paraffin wax and 11.5 parts of a maleic anhydride-grafted ethylene-vinyl acetate copolymer (where maleic anhydride had a grafting rate of 1.2%) were put into a constant-temperature oil bath with an electric stirrer and heated to melting, and stirred at 300 r/min for 60 min to obtain a primary mixture;

20 parts of melamine and 5 parts of triphenyl phosphate were added to the primary mixture, and stirred at 150° C. and 500 r/min for 120 min to obtain a secondary mixture; and

3.5 parts of expanded graphite was added to the secondary mixture, and stirred at 500 r/min and 150° C. for 120 min to obtain the phase change composite (denoted as MTPCM1).

### Example 2

60 parts of Joule paraffin wax and 11.5 parts of a maleic anhydride-grafted ethylene-vinyl acetate copolymer (where maleic anhydride had a grafting rate of 1.2%) were put into a constant-temperature oil bath with an electric stirrer and heated to melting, and stirred at 300 r/min for 60 min to obtain a primary mixture;

15 parts of melamine and 10 parts of triphenyl phosphate were added to the primary mixture, and stirred at 150° C. and 500 r/min for 120 min to obtain a secondary mixture; and

3.5 parts of expanded graphite was added to the secondary mixture, and stirred at 500 r/min and 150° C. for 120 min to obtain the phase change composite (denoted as MTPCM2).

### Example 3

60 parts of Joule paraffin wax and 11.5 parts of a maleic anhydride-grafted ethylene-vinyl acetate copolymer (where maleic anhydride had a grafting rate of 1.2%) were put into a constant-temperature oil bath with an electric stirrer and heated to melting, and stirred at 300 r/min for 60 min to obtain a primary mixture;

10 parts of melamine and 15 parts of triphenyl phosphate were added to the primary mixture, and stirred at 150° C. and 500 r/min for 120 min to obtain a secondary mixture; and

3.5 parts of expanded graphite was added to the secondary mixture, and stirred at 500 r/min and 150° C. for 120 min to obtain the phase change composite (denoted as MTPCM3).

### Example 4

60 parts of Joule paraffin wax and 11.5 parts of a maleic anhydride-grafted ethylene-vinyl acetate copolymer (where maleic anhydride had a grafting rate of 1.2%) were put into a constant-temperature oil bath with an electric stirrer and heated to melting, and stirred at 300 r/min for 60 min to obtain a primary mixture;

5 parts of melamine and 20 parts of triphenyl phosphate were added to the primary mixture, and stirred at 150° C. and 500 r/min for 120 min to obtain a secondary mixture; and

3.5 parts of expanded graphite was added to the secondary mixture, and stirred at 300 r/min and 150° C. for 120 min to obtain the phase change composite (denoted as MTPCM4).

### Comparative Example 1

60 parts of Joule paraffin wax and 40 parts of a maleic anhydride-grafted ethylene-vinyl acetate copolymer (where maleic anhydride had a grafting rate of 1.2%) were put into a constant-temperature oil bath with an electric stirrer and heated to melting, and stirred at 300 r/min for 60 min to obtain a phase change composite (denoted as PE).

### Comparative Example 2

60 parts of Joule paraffin wax and 36.5 parts of a maleic anhydride-grafted ethylene-vinyl acetate copolymer (where maleic anhydride had a grafting rate of 1.2%) were put into a constant-temperature oil bath with an electric stirrer and heated to melting, and stirred at 300 r/min for 60 min to obtain a mixture; and

3.5 parts of expanded graphite was added to the mixture, and stirred at 500 r/min and 150° C. for 120 min to obtain the phase change composite (denoted as PEE).

### Comparative Example 3

60 parts of Joule paraffin wax and 11.5 parts of a maleic anhydride-grafted ethylene-vinyl acetate copolymer (where maleic anhydride had a grafting rate of 1.2%) were put into a constant-temperature oil bath with an electric stirrer and heated to melting, and stirred at 300 r/min for 60 min to obtain a primary mixture;

25 parts of melamine was added to the primary mixture, and stirred at 150° C. and 500 r/min for 120 min to obtain a secondary mixture; and

3.5 parts of expanded graphite was added to the secondary mixture, and stirred at 500 r/min and 150° C. for 120 min to obtain the phase change composite (denoted as MPCM).

### Comparative Example 4

60 parts of Joule paraffin wax and 11.5 parts of a maleic anhydride-grafted ethylene-vinyl acetate copolymer (where maleic anhydride had a grafting rate of 1.2%) were put into a constant-temperature oil bath with an electric stirrer and heated to melting, and stirred at 300 r/min for 60 min to obtain a primary mixture;

25 parts of triphenyl phosphate was added to the primary mixture, and stirred at 150° C. and 500 r/min for 120 min to obtain a secondary mixture; and

3.5 parts of expanded graphite was added to the secondary mixture, and stirred at 500 r/min and 150° C. for 120 min to obtain the phase change composite (denoted as TPCM).

The proportioning of each component in Examples 1 to 4 and Comparative Examples 1 to 4 was shown in Table 1:

TABLE 1
Proportioning of each component in Examples 1 to 4 and Comparative Examples 1 to 4

| | | Maleic anhydride-grafted | | | |
|---|---|---|---|---|---|
| | Joule paraffin | ethylene-vinyl acetate | Expanded | Melamine/ | Triphenyl |
| | wax/parts | copolymer/parts | graphite/parts | parts | phosphate/parts |
| Example 1 | 60 | 11.5 | 3.5 | 20 | 5 |
| Example 2 | 60 | 11.5 | 3.5 | 15 | 10 |
| Example 3 | 60 | 11.5 | 3.5 | 10 | 15 |
| Example 4 | 60 | 11.5 | 3.5 | 5 | 20 |
| Comparative Example 1 | 60 | 40 | — | — | — |
| Comparative Example 2 | 60 | 36.5 | 3.5 | — | — |
| Comparative Example 3 | 60 | 11.5 | 3.5 | 25 | |
| Comparative Example 4 | 60 | 11.5 | 3.5 | — | 25 |

Performance Testing

### Test Example 1

The melting point, thermal conductivity, and latent heat value of the phase change composites of Examples 1 to 4 and Comparative Examples 1 to 4, the Joule paraffin wax, and the triphenyl phosphate were tested; and the test results were shown in Table 2:

TABLE 2
Physical and thermal performance test results of
phase change composites of Examples 1 to 4 and
Comparative Examples 1 to 4 and raw materials

| | | | Thermal |
|---|---|---|---|
| | Melting | Latent heat | conductivity/ |
| | point/° C. | value/J · g⁻¹ | W · m⁻¹ · K⁻¹ |
| Example 1 | 47.8 | 117.5 | 1.30 |
| Example 2 | 46.9 | 115.6 | 1.25 |
| Example 3 | 47.5 | 125.7 | 1.39 |
| Example 4 | 47.3 | 130.0 | 1.37 |
| Comparative Example 1 | 47.3 | 112.5 | 0.26 |
| Comparative Example 2 | 47.6 | 109.9 | 1.12 |
| Comparative Example 3 | 48.2 | 118.4 | 1.28 |
| Comparative Example 4 | 47.3 | 130.6 | 1.38 |
| Joule paraffin wax | 48.8 | 225.7 | — |
| Triphenyl phosphate | 50.7 | 82.4 | — |

It was seen from Table 2 that the phase change composite had a melting point of 46.9° C. to 47.8° C., which was close to a melting point of 48.8° C. of the raw material Joule paraffin wax, indicating that during the preparation, the Joule paraffin wax did not undergo chemical reactions and could remain a relatively stable structure;
the triphenyl phosphate had a melting point of 50.7° C., which was close to the melting point of 48.8° C. of the Joule paraffin wax, and had a latent heat value of 82.4 J/g, indicating that the triphenyl phosphate could not only be used as a flame retardant in the phase change composite, but also could act as a phase change component;
with an increase of the triphenyl phosphate content in the system, the latent heat value of the phase change composite did not increase immediately; the reason might be that the increase of a small amount of the triphenyl phosphate could promote the amidation of melamine and maleic anhydride-grafted ethylene-vinyl acetate copolymer under heating, and chemical coupling of the two could limit the thermal movement of paraffin wax chain segments, thereby reducing the overall latent heat value of the phase change composite; when the content of triphenyl phosphate increased to a certain value, the triphenyl phosphate acted as a compatibilizer, which could promote the uniform dispersion of each component in the system to provide more space for the movement of the paraffin chain segments; the triphenyl phosphate itself could also absorb a certain amount of heat, thereby increasing the latent heat value of the phase change composite, where the latent heat values of the phase change composites obtained in Example 3 and Example 4 were 125.7 J/g and 130.0 J/g, respectively.

### Test Example 2

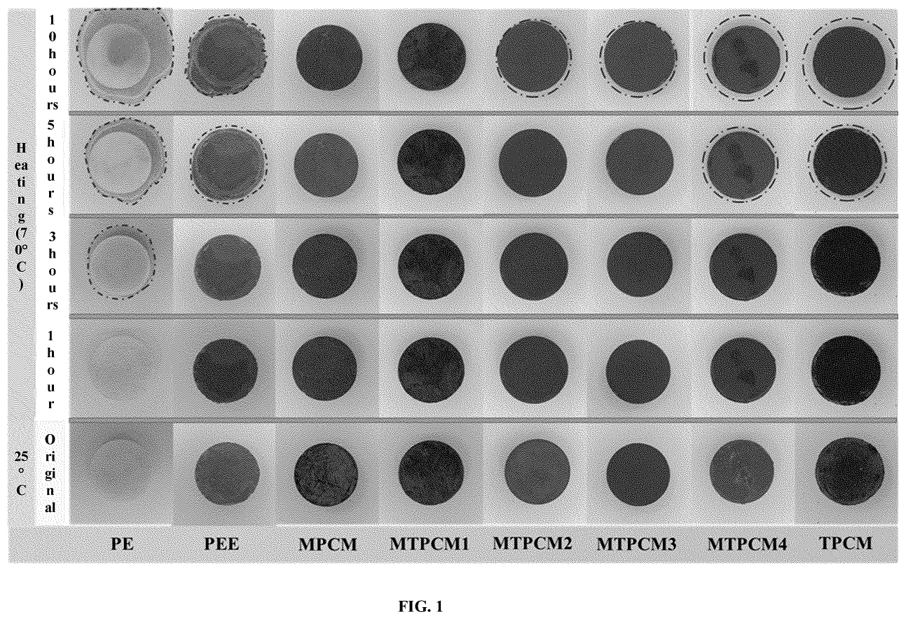

the anti-leakage performance of the phase change composites obtained in Examples 1 to 4 and Comparative Examples 1 to 4 was detected; a test process included: different samples were prepared into a size of Φ12×8 mm, placed on a heating platform, and the test was continued at a relatively high temperature of 70° C. for 10 h, digital photos of the samples were recorded using a digital camera, and the shape change and leakage of samples were compared at various temperatures;
an obtained test chart was shown in FIG. 1;
as shown in FIG. 1, the phase change composites obtained in Comparative Example 1 and Comparative Example 2 collapsed during heating; the collapse of Comparative Example 1 was more serious than that of Comparative Example 2, because a thermoplastic linear framework of Comparative Example 1 did not possess thermal corrosion resistance; the expanded graphite in the phase change composite of Comparative Example 2 could absorb a large amount of paraffin wax, such that the thermal stability of the phase change composite was significantly enhanced; in sharp contrast to Comparative Example 1 and Comparative Example 2, the sample of Comparative Example 3 did not collapse and had a desirable shape stability;
the composites obtained in Examples 1 to 4 showed excellent thermal stability and anti-leakage performance, indicating that the melamine and triphenyl phosphate could further improve the anti-leakage performance and structural stability; the melamine could be chemically coupled with the maleic anhydride-grafted ethylene-vinyl acetate copolymer, reducing a phase interfacial tension of each phase in the composite to suppress macroscopic phase separation, and increasing a bonding force between the phases of the composite; as a result, molecular chains were entangled with each other and difficult to move, such that the viscosity of the melt increased to improve the anti-leakage performance;

From Test Examples 1 and 2, it was seen that the phase change composite had high latent heat value and thermal conductivity, as well as well leakage resistance and thermal stability, which was suitable for thermal management of power batteries.

### Test Example 3

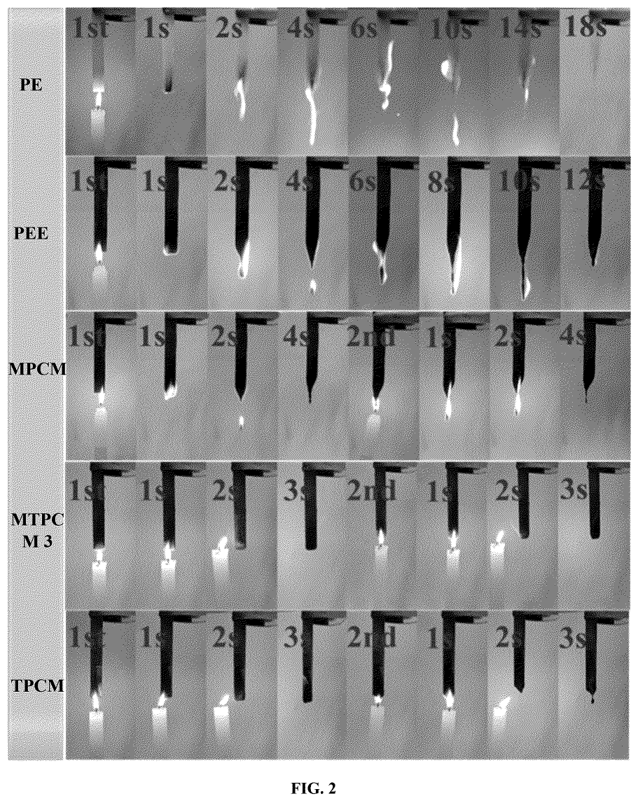

A vertical combustion test and a cone calorimeter test were conducted on the phase change composites obtained in Example 3 and Comparative Examples 1 to 4;
the vertical combustion test was conducted according to a UL-94 flame-retardant grade test standard, and the test sample had a size of 130 mm×6.5 mm×3.2 mm; a vertical combustion test curve was shown in FIG. 2.

As shown in FIG. 2, the flame retardant grade of the composite PE obtained in Comparative Example 1 was V2; when the PE was ignited, a thin layer of carbon was rapidly formed on its surface, which might drip with the molten paraffin wax and continue to combust for 18 sec. When expanded graphite was added, although the expanded graphite could form an effective carbonized layer on the surface of the material, it could not further form a dense carbonized interface layer during the combustion; therefore, the flame retardant effect of the composite PEE obtained in Comparative Example 2 was poor, with a flame retardant grade of still V2. Melamine was added to the phase change composite obtained in Comparative Example 3, the melamine could absorb heat and sublime, releasing difficult-to-combustible gases, including N₂, H₂O and NO₂, so as to dilute oxygen and combustible gases in the gas phase; the phase change composite MPCM obtained in Comparative Example 3 had obvious reduction of combustion substances, and showed a combustion time 36.6% lower than that of PEE; however, there were still combustibles falling during the combustion, which could be ignited twice, and a flame retardant grade of the MPCM was still V2; the results indicated that the single flame retardant, melamine, had a limited flame retardant effect in the system. With the introduction of the flame retardant triphenyl phosphate, the flame retardant effect of the composite was improved; and the composite MTPCM3 obtained in Example 3 and the composite TPCM obtained in Comparative Example 4 both reached a VO level. In the vertical combustion test, both MTPCM3 and TPCM were extinguished 2 sec after ignition, and could not be re-ignited. This showed that there was a synergistic effect between the triphenyl phosphate and melamine, resulting in excellent flame retardancy.

The cone calorimetry test was conducted in accordance with a test standard ISO 5660 at a heat flux of 35 kW/m², where each result was an average of two parallel tests;

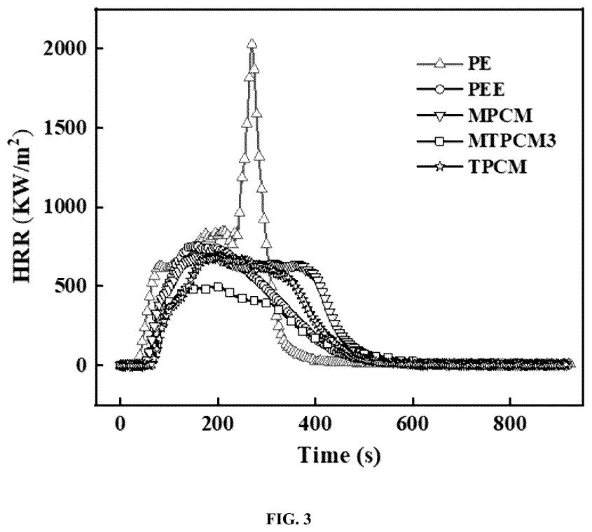

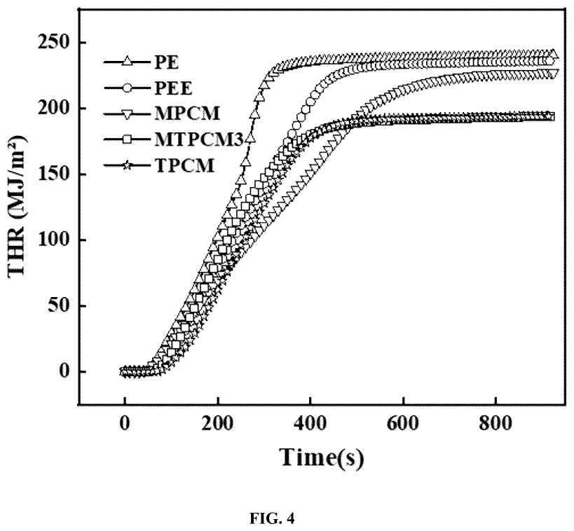

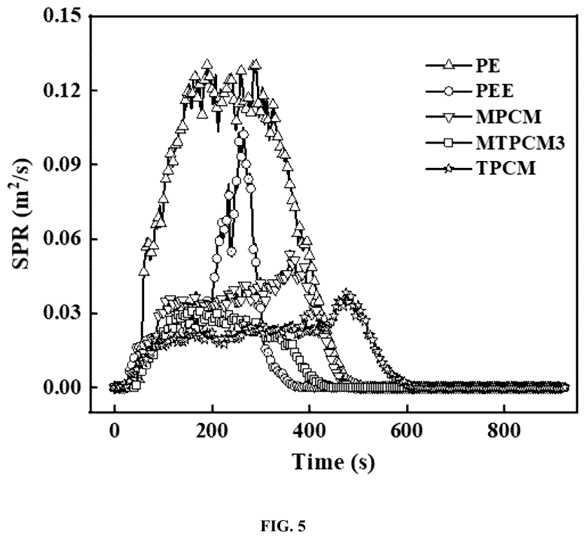

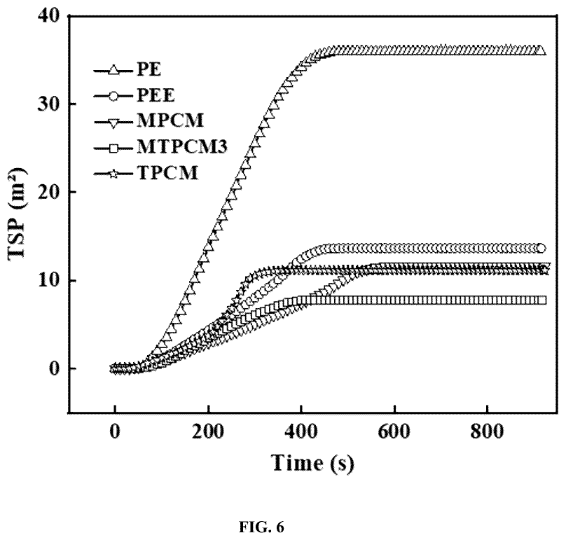

The test results were shown in Table 3; where the HRR test curve was shown in FIG. 3; the THR rate test curve was shown in FIG. 4, the SPR test curve was shown in FIG. 5, and the TSP rate test curve was shown in FIG. 6.

TABLE 3
UL-94 test grades and cone calorimetry peak test
results of phase change composites obtained
in Example 3 and Comparative Examples 1 to 4

| | UL-94 | PHHR/ | THR/ | SPR/ | TSP/ |
|---|---|---|---|---|---|
| | level | (KW/m²) | (MJ/m²) | (m²/s) | (m²) |
| Example 3 | V0 | 499.4 | 193.5 | 0.03 | 7.8 |
| Comparative Example 1 | V2 | 2029.4 | 240.1 | 0.13 | 36.0 |
| Comparative Example 2 | V2 | 754.9 | 236.1 | 0.10 | 13.6 |
| Comparative Example 3 | V2 | 696.5 | 226.9 | 0.06 | 11.7 |
| Comparative Example 4 | V0 | 688.1 | 193.8 | 0.04 | 11.2 |

As shown in FIG. 3, after 270 sec of ignition, the HRR value of the composite PE obtained in Comparative Example 1 rose sharply to a maximum of 2014.7 kW/m²; the higher HRR and PHRR (peak HRR) of the material burning meant the higher fire hazard of the material. The HRR of PE had two obvious peaks, the reason may be that the heat of vaporization of paraffin wax and maleic anhydride graft was different, and the highest peak corresponded to the flammability of maleic anhydride graft;

when adding the expanded graphite and flame retardant, the HRR value of the phase change composite dropped sharply; it was seen that when expanded graphite was added to the composite, the expanded graphite covered the surface of the material and improved the thermal stability of the carbon layer;

In addition, with the addition of expanded graphite and flame retardant, the ignition time of phase change composites was delayed; the ignition times of PEE, MPCM, MTPCM3, and TPCM were 30 sec, 34 sec, 45 sec, and 55 sec, respectively, indicating that the expanded graphite and flame retardant could effectively reduce the fire hazard of phase change composites. When the phase change composite was exposed to the flame, the triphenyl phosphate therein melted first, and its relatively low melting point shortened a response time of combustion, and the expanded graphite might also migrate on the surface of the material to form a first carbonized layer, prolonging the fire time of the material and protect the material from decomposition; as the temperature rose, the melamine absorbed heat and sublimated, releasing flammable gases, including N₂, H₂O and NO₂, diluting oxygen and combustible gases in the gas phase, thereby inhibiting or slowing down the combustion reaction; in addition, the triphenyl phosphate could also volatilize into the gas phase when heated, and then decomposed by heat to generate phosphorus-containing free radicals, which volatilized into the gas phase to capture active free radicals and played a role in gas-phase flame retardancy.

From the THR rate in FIG. 4, it was seen that the THR of MTPCM3 at 800 sec was 193.5 MJ/m², which was significantly lower than that of PE, PEEG, and MPCM; while the THR values of MTPCM3 and TPCM were highly close; It showed that TPP contributed more to the reduction of HRR.

It was seen from FIG. 5 and FIG. 6 that the SPR peak of PE reached 0.14 m²/s during the combustion, and the TSP rate was also significantly higher than that of other phase change composites, indicating that the expanded graphite and the flame retardant inhibited the combustion and smoke generation of the phase change composite to a certain extent.

### Test Example 4

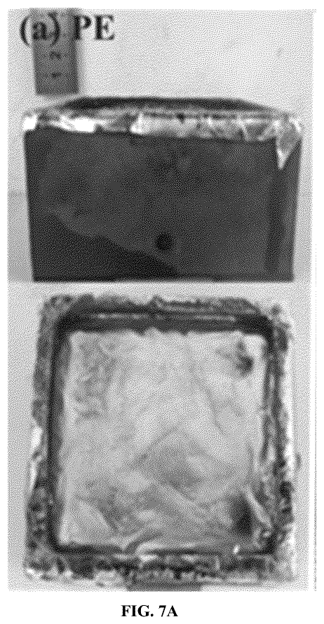

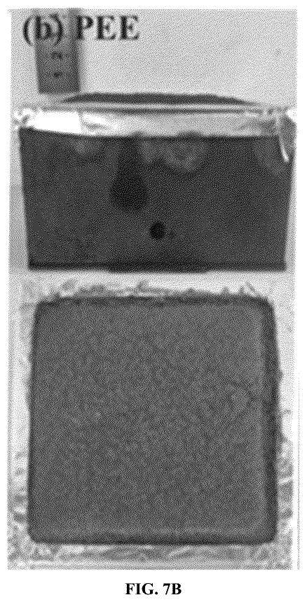

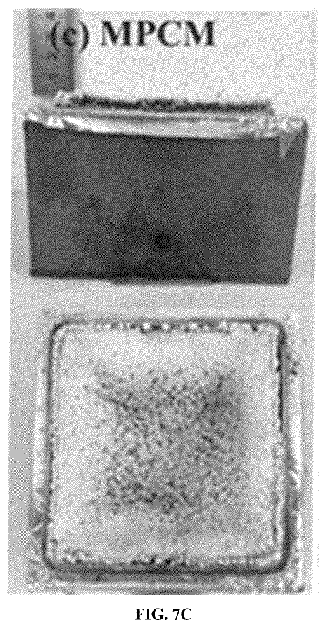

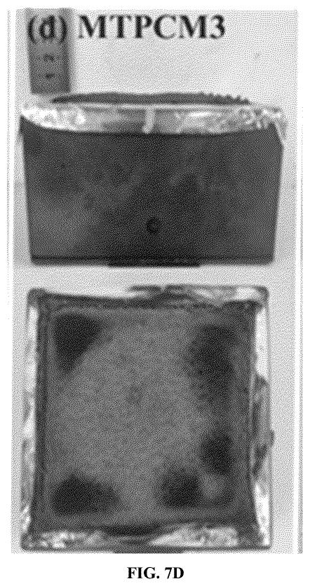

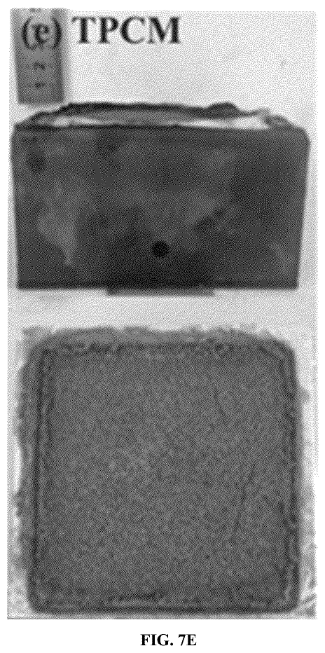

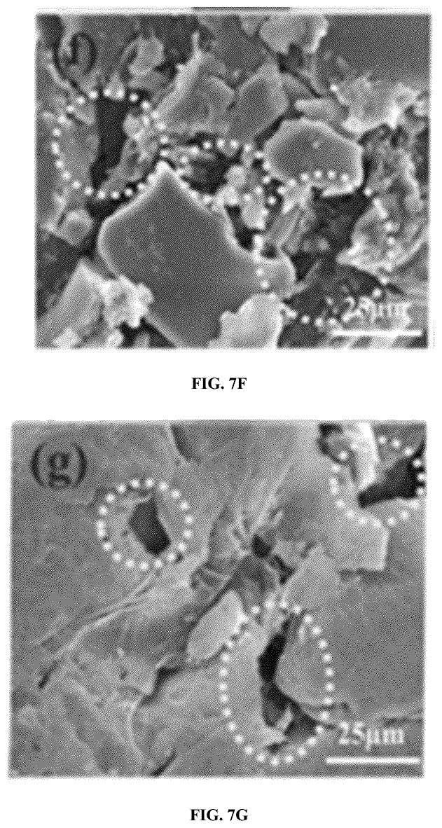

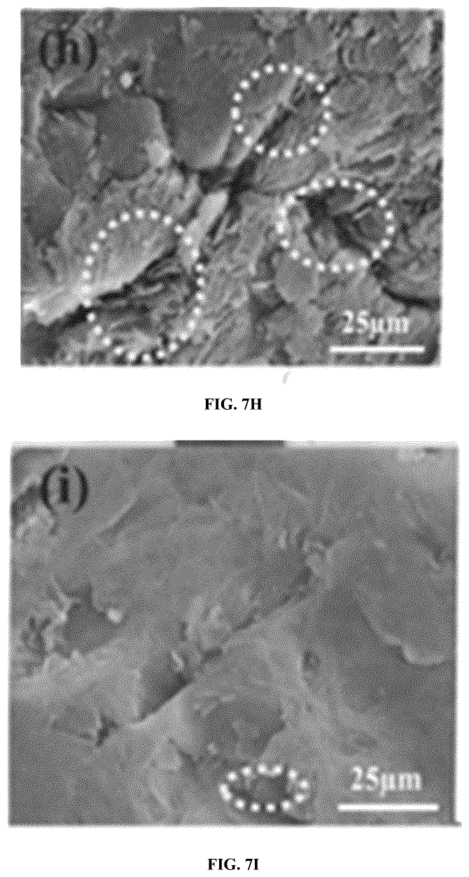

FIGS. 7A-J showed a real picture and a SEM image of a material obtained after the phase change composites obtained in Example 3 and Comparative Examples 1 to 4 were combusted; where FIG. 7A and FIG. 7F were the real figure and the SEM image of Comparative Example 1, respectively; FIG. 7B and FIG. 7G were the real figure and the SEM image of Comparative Example 2, respectively; FIG. 7C and FIG. 7H were the real figure and the SEM image of Comparative Example 3, respectively; FIG. 7D and FIG. 7I were the real figure and the SEM image of Example 3, respectively; and FIG. 7E and FIG. 7J were the real figure and the SEM image of Comparative Example 4, respectively;

from FIG. 7A and FIG. 7F, it was seen that there was very little carbon residue after PE combustion, and the surface carbon layer was incomplete and presented obvious cracks;
it was seen from FIG. 7B and FIG. 7G that after adding the expanded graphite, the surface of the PEE carbon layer exhibited cracks of varying degrees, and air entered the surface of the substrate through the cracks to provide sufficient oxygen for the fuel, thereby intensifying the combustion of the material;
in contrast, it was seen from FIG. 7C and FIG. 7H that when only melamine was added, nitrogen and nitrogen dioxide produced by the decomposition of melamine could effectively prevent the entry of oxygen at the initial stage of material combustion; however, the surface of the MPCM carbon layer was loose and porous, and gas overflowed during the combustion, which still could not prevent the spread of the flame in the later stage;
it was seen from FIG. 7E and FIG. 7J that when only triphenyl phosphate was added, there were still some cracks on the surface of the material, the reason was that a single TPP was difficult to form a dense isolation layer; and
it was seen from FIG. 7D and FIG. 7I that after melamine and triphenyl phosphate were added to the phase change composite, the triphenyl phosphate was decomposed into strongly-dehydrated substances (such as metaphosphoric acid); at high temperatures, the strongly-dehydrated substances could cover the surface of the material to form a non-combustible material, which promoted the dehydration of the phase change composite into carbon, forming a more effective protective carbon layer.

### Test Example 5

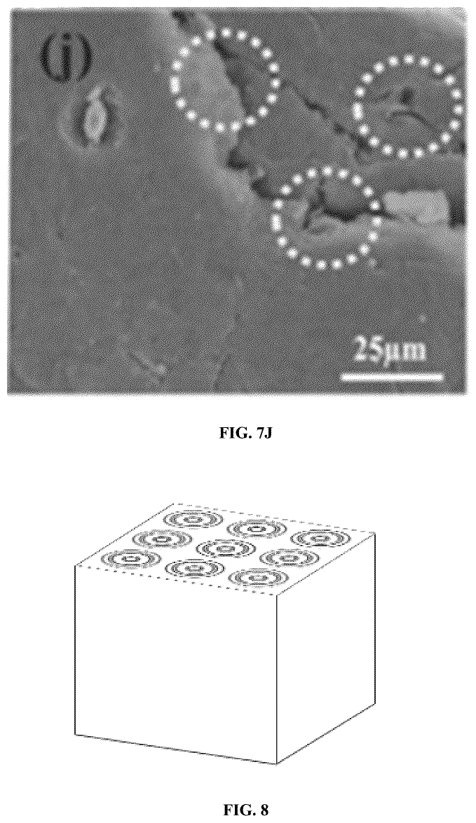

With the phase change composite obtained in Example 3 as a raw material, a battery holder was prepared, and then assembled to obtain a decommissioned power battery module (MTPCM3-Module); a temperature control performance was tested at a 3C high discharge rate, while a control group was a traditional forced air-cooled decommissioned power battery module (FAC-Module);
both the MTPCM3-Module and the FAC-Module were obtained by connecting 9 32650-type decommissioned batteries with a 3S×3P (three-series-three-parallel) structure (a schematic diagram of the structure was shown in FIG. 8), and each decommissioned 32650-type battery had an average capacity of 4,100 mAh; the battery module was put into a thermostat (BTH 80C, Guangdong Bell Experiment Equipment Co., Ltd.), and charge-discharge was conducted on the battery module under a simulated ambient constant temperature at 30° C. using a battery test system (CT-3008-NA, Shenzhen Xinwei Technology Co., Ltd.); a surface temperature of the battery was collected through a T-type thermocouple (TT-T-30, Shanghai Laiying Technology Co., Ltd.) and transmitted to a collection device Agilent (34970A, Keysight Technologies Co., Ltd., USA) for monitoring; the experimental data was collected through a supporting computer system, to obtain a surface temperature change curve of the battery module during the charge-discharge.

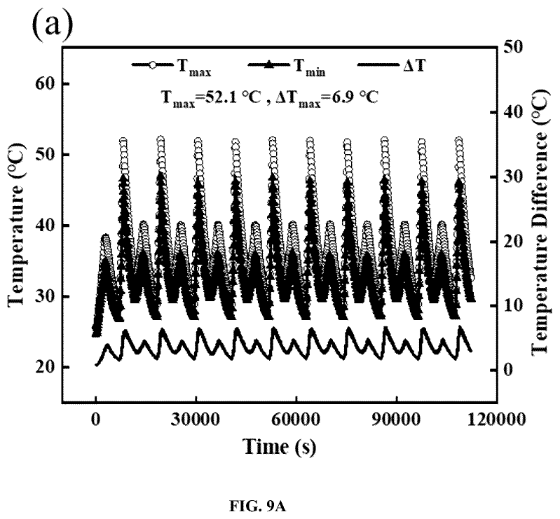

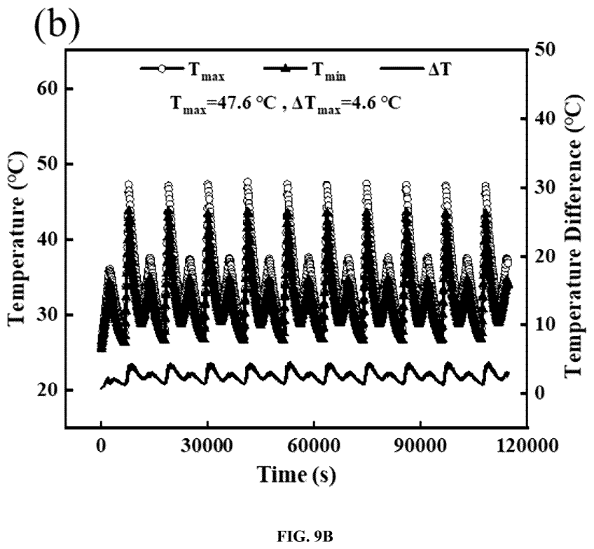

The temperature change curve was shown in FIGS. 9A-B, where FIG. 9A was the FAC-Module, and FIG. 9B was the MTPCM3-Module. It was seen from FIG. 9A and FIG. 9B that the melting point of MTPCM3 was 47.5° C.; after phase change (higher than 47.5° C.), the heating rate of MTPCM3-Module was obviously lower than that of FAC-Module module. Compared with a maximum temperature of the FAC-Module, a maximum temperature of the MTPCM3-Module module was lower, and the cooling performance of MTPCM3 was undoubtedly attributed to its higher thermal conductivity and enthalpy. This conclusion was further confirmed by comparing the maximum temperature difference of the batteries in different modules.

As shown in FIGS. 9A-B, a ΔTmax growth rate of the MTPCM3-Module module was lower than that of the FAC-Module module. This was because the higher thermal conductivity of MTPCM3 more effectively facilitated heat transfer to the entire module, resulting in a more uniform temperature distribution. During the 1C-rate charge and 3C-rate discharge, the ΔTmax of the MTPCM3-Module was 4.6° C., which was 2.3° C. lower than the ΔTmax of the FAC-Module. The above results show that the decommissioned power battery module based on MTPCM3 phase change composite cooling has significantly-reduced maximum temperature and maximum temperature difference than those of forced air cooling, showing excellent thermal conductivity and heat dissipation. It shows that the phase change composite provided by the present disclosure can endow the battery module with more stable heat dissipation performance during the actual repeated charging and discharging.

Although the present disclosure is described in detail in conjunction with the foregoing examples, they are only a part of, not all of, the examples of the present disclosure. Other examples can be obtained based on these examples without creative efforts, and all of these examples shall fall within the protection scope of the present disclosure.

What is claimed is:

1. A phase change composite, comprising the following components in parts by weight:
50 parts to 70 parts of a phase change material (PCM), 10 parts to 20 parts of a maleic anhydride graft, 1 part to 5 parts of a thermal conductivity enhancer, and 15 parts to 30 parts of a flame retardant; wherein
the flame retardant comprises melamine and triphenyl phosphate.

2. The phase change composite according to claim 1, comprising the following components in parts by weight:
50 parts to 60 parts of the PCM, 11.5 parts to 20 parts of the maleic anhydride graft, 1 part to 3.5 parts of the thermal conductivity enhancer, and 15 parts to 25 parts of the flame retardant.

3. The phase change composite according to claim 1, wherein the maleic anhydride graft is one or more selected from the group consisting of a maleic anhydride-grafted ethylene-vinyl acetate copolymer, a maleic anhydride-grafted ethylene-butene copolymer, and a maleic anhydride-grafted ethylene-1-octene copolymer.

4. The phase change composite according to claim 1, wherein the thermal conductivity enhancer is one or more selected from the group consisting of boron nitride, expanded graphite, and aluminum nitride.

5. The phase change composite according to claim 1, wherein the PCM is one or more selected from the group consisting of paraffin wax, stearic acid, lauric acid, and polyvinyl alcohol.

6. The phase change composite according to claim 1, wherein the melamine and the triphenyl phosphate are at a mass ratio of 1:10 to 10:1.

7. The phase change composite according to claim 2, wherein the melamine and the triphenyl phosphate are at a mass ratio of 1:10 to 10:1.

8. The phase change composite according to claim 3, wherein the melamine and the triphenyl phosphate are at a mass ratio of 1:10 to 10:1.

9. The phase change composite according to claim 4, wherein the melamine and the triphenyl phosphate are at a mass ratio of 1:10 to 10:1.

10. The phase change composite according to claim 5, wherein the melamine and the triphenyl phosphate are at a mass ratio of 1:10 to 10:1.

11. A preparation method of the phase change composite according to claim 1, comprising the following steps:
mixing the PCM, the maleic anhydride graft, the thermal conductivity enhancer, and the flame retardant to obtain the phase change composite.

12. The preparation method according to claim 11, comprising the following components in parts by weight:
50 parts to 60 parts of the PCM, 11.5 parts to 20 parts of the maleic anhydride graft, 1 part to 3.5 parts of the thermal conductivity enhancer, and 15 parts to 25 parts of the flame retardant.

13. The preparation method according to claim 11, wherein the maleic anhydride graft is one or more selected from the group consisting of a maleic anhydride-grafted ethylene-vinyl acetate copolymer, a maleic anhydride-grafted ethylene-butene copolymer, and a maleic anhydride-grafted ethylene-1-octene copolymer.

14. The preparation method according to claim 11, wherein the thermal conductivity enhancer is one or more selected from the group consisting of boron nitride, expanded graphite, and aluminum nitride.

15. The preparation method according to claim 11, wherein the PCM is one or more selected from the group consisting of paraffin wax, stearic acid, lauric acid, and polyvinyl alcohol.

16. The preparation method according to claim 11, wherein the melamine and the triphenyl phosphate are at a mass ratio of 1:10 to 10:1.

17. The preparation method according to claim 12, wherein the melamine and the triphenyl phosphate are at a mass ratio of 1:10 to 10:1.

18. The preparation method according to claim 11, wherein the mixing is conducted at 120° C. to 180° C.

19. The preparation method according to claim 11, wherein a process of the mixing comprises the following steps:
conducting primary mixing on the PCM and the maleic anhydride graft to obtain a primary mixture;
conducting secondary mixing on the primary mixture and the flame retardant to obtain a secondary mixture; and
conducting tertiary mixing on the secondary mixture and the thermal conductivity enhancer.

20. The preparation method according to claim 18, wherein a process of the mixing comprises the following steps:
conducting primary mixing on the PCM and the maleic anhydride graft to obtain a primary mixture;
conducting secondary mixing on the primary mixture and the flame retardant to obtain a secondary mixture; and
conducting tertiary mixing on the secondary mixture and the thermal conductivity enhancer.
